(19) United States
(12) Patent Application Publication
(10) Pub. No.: US 2012/0218201 A1
(43) Pub. Date: Aug. 30, 2012

(54) User-Friendly Process for Interacting with Information Content on Touchscreen Devices

(75) Inventors: Alexis Tamas, Paris (FR); Amaury Grimbert, Paris (FR)

(73) Assignee: STG Interactive S.A., Paris (FR)

(21) Appl. No.: 13/364,146

(22) Filed: Feb. 1, 2012

Related U.S. Application Data
(63) Continuation of application No. PCT/EP2010/054078, filed on Mar. 29, 2010.
Application No. PCT/EP2010/054078 is a continuation of application No. 12/615,501, filed on Nov. 10, 2009.
Application No. 12/615,501 is a continuation-in-part of application No. 12/615,501, filed on Nov. 10, 2009.
(60) Provisional application No. 61/164,606, filed on Mar. 30, 2009.
(60) Provisional application No. 61/164,606, filed on Mar. 30, 2009.

(51) Int. Cl. G06F 3/041

(52) U.S. Cl. 345/173

(57) ABSTRACT

An electronic device includes a touchscreen and an electrical circuit. The electrical circuit controls a display of the touchscreen and detects user contact with a surface of the touchscreen. The electrical circuit divides the display into at least two distinct display zones including an informational display zone and a command display zone. The informational display zone displays informational content including functional objects, each of the functional objects being associated with a data processing function. The command display zone displays a graphic representation of a command pad. In response to detecting a first predetermined tactile action on the command pad, the electrical circuit graphically modifies one of the functional objects of the informational display zone to indication selection of the one of the functional objects. In response to detecting a second predetermined tactile action, the electrical circuit initiates execution of the data processing function associated with the selected functional object.

### CROSS-REFERENCE TO RELATED APPLICATIONS

This application is a continuation of PCT International Application No. PCT/EP2010/054078, filed on Mar. 29, 2010, which claims priority to U.S. Nonprovisional application Ser. No. 12/615,501, filed Nov. 9, 2009 and U.S. Provisional Application No. 61/164,606, filed Mar. 30, 2009. This application is also a continuation-in-part of U.S. Nonprovisional application Ser. No. 12/615,501, filed Nov. 9, 2009, which claims the benefit of U.S. Provisional Application No. 61/164,606, filed Mar. 30, 2009. The disclosures of the above applications are incorporated herein by reference in their entirety.

### BACKGROUND AND SUMMARY

It is known in the state of the art an existing solution implementing a simple screen or touchscreen, as well as one or more electromechanical elements such as a hardware button, scroll wheel or trackball. The use of such an electrotromechanical element implicates a significant cost relating not only to the cost of the component, but also to the complexity of the assembly and maintenance processes. Moreover, since these elements are heavily used by the user, they may break down, making the equipment concerned virtually impossible to use.

It is known in the state of the art another solution implementing a multi-touch screen allowing the selection of an interactive function through a tactile action on the display surface. This solution is not fully satisfactory. Firstly, the user hides a portion of the displayed information when he puts his finger on the tactile surface, which can lead to selection errors. Secondly, this solution often requires arbitration between the size reduction of the displayed objects, in order to enrich the content presented to the user, and an increase of the size of these same objects, for a selection to be made with reasonable dexterity. This arbitration often being difficult, the user has no other solution than repeatedly modify the enlargement of the displayed objects by using the “zoom” functions. This way of proceeding is not very ergonomic and results in an increased consumption of electricity, each change in size requiring resampling processes of the content by the CPU, as well as recalculations of the processes for the multi-touch detections.

The purpose of the current invention is to solve these problems by proposing an inexpensive equipment, together with a reduced electrical consumption and a greater reliability, as well as with improved ergonomics as compared to the existing solutions (prior art). The user may use all the functions with a single hand, contrary to multi-touch solutions which require the actions of multiple fingers of the same hand, the other hand holding the equipment. In addition, the invention makes it possible to offer all the functional richness of the solutions of prior art when using touch screens that do not detect several simultaneous contact points.

US patent application US19970037874 describes a method for improving the productivity and usability of a graphical user interface by employing various methods to switch between different cursors which perform different types of functions. The invention exploits the absolute and relative positioning capabilities of certain types of pointing devices to improve the productivity and usability of various types of graphical user interfaces. The invention provides a method for using a gesture, motion or initial position with a pointing device to select a function, followed by a subsequent motion, which is used to select a value.

US 2006197753 patent application discloses a multi-functional handheld device capable of configuring user inputs based on how the device is to be used. Preferably, the multi-functional handheld device has at most only a few physical buttons, keys, or switches so that its display size can be substantially increased. The multi-functional hand-held device also incorporates a variety of input mechanisms, including touch sensitive screens, touch sensitive housings, display actuators, audio input, etc. The device also incorporates a user-configurable GUI for each of the multiple functions of the devices.

French patent FR 2625344 relates to a novel chess board system making it possible to no longer make use of movable pieces such as the pieces of a chess game or the chequers of draughts. It consists of a box supporting, on top, a screen visually displaying the pieces in two dimensions, itself surmounted by a transparent touch-sensitive keyboard linked to a microprocessor for recognizing the commands and the squares of the game. The movement of the pieces takes place directly by virtue of pressure of the finger on the said keyboard.

US2009203408 patent application relates to a system and method for a user interface for key-pad driven devices, such as mobile phones. The user interface provides an ability to control two simultaneous focus elements on a display screen at once. Each focus element can be controlled by a separate set of keys, for example. Each focus element may be included within separate control content areas of the user interface.

US 2009087095 patent application relates to a computer implemented method for a touch screen user interface for a computer system. A first touchscreen area is provided for accepting text input strokes. A second touchscreen area is provided for displaying recognized text from the text input strokes. The text input strokes are displayed in the first touchscreen area. The text input strokes are recognized and the resulting recognized text is displayed in the second touchscreen area. A portion of the recognized text is displayed in the first touchscreen area, wherein the portion of the recognized text is shown as the text input strokes are recognized. The portion of the recognized text displayed scrolls as the new text input strokes are recognized. The portion of the recognized text in the first touchscreen area can be displayed in a different format with respect to the recognized text in the second touchscreen area. The text input strokes in a first part of the first touchscreen area are graphically shown as they are being recognized by the computer system. The touchscreen user interface method can be implemented on a PID (personal information device) and can be implemented on a palmtop computer system.

### DEFINITIONS

In the following invention:

“Touchscreen” is a display that can detect the presence and location of a touch within the display surface or on a part of the display surface. The term generally refers to a touch or contact to the display of the device by a finger or hand. Touchscreens can also sense other passive objects, such as a stylus.

“Informational content” refers to graphical or textual information presented by applications running on the device. Part of the content may be issued from remote servers (e.g. web pages presented in a web browser application).

An informational content includes one or more functional objects corresponding to specific user actions. Functional objects may be of any size, including small sizes, depending on the design of the informational content. In this context, on an electronic device with a touchscreen, when using a finger, the touch area (finger contact area) on the touchscreen may be much larger than the functional objects in the information content. In such a case, interacting with content may not be possible for users without generating errors (e.g. touching an adjacent functional object).

Moreover, in prior art, touching the display with a finger hides a portion of the content beneath, which diminishes the user's accessibility to the informational content. This problem can be aggravated when the device display pitch is small because functional objects can be displayed particularly small in this case.

Software solutions exist in which users may zoom in to the informational content to magnify the functional objects so that they become larger than the touch area. These solutions are not user-friendly because users have to zoom in and out very frequently (zooming out is necessary for viewing the entire visible content). Moreover, zooming in and out will result in an increased power consumption if the effect is implemented using multi-touch detection (e.g. the iPhone™)

### BRIEF DESCRIPTION OF THE DRAWINGS

FIGS. 1-8 are views of an embodiment of the electronic device.

### DETAILED DESCRIPTION

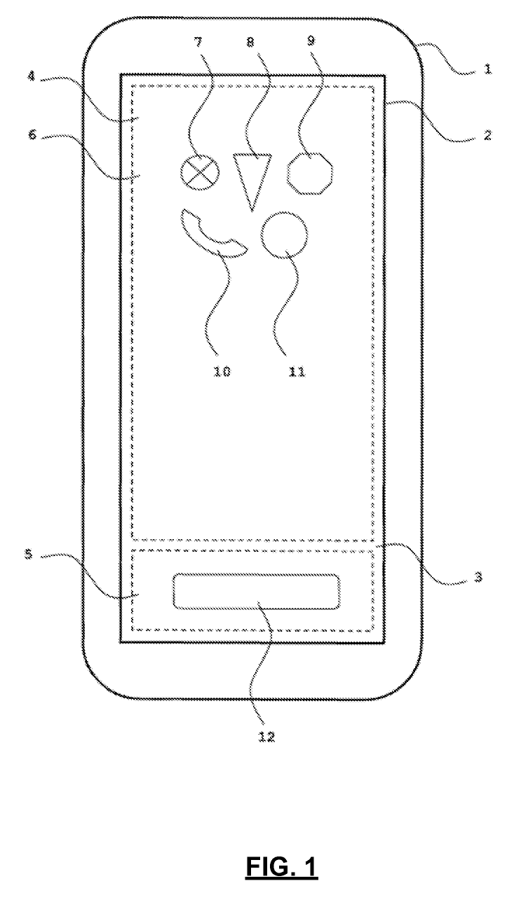

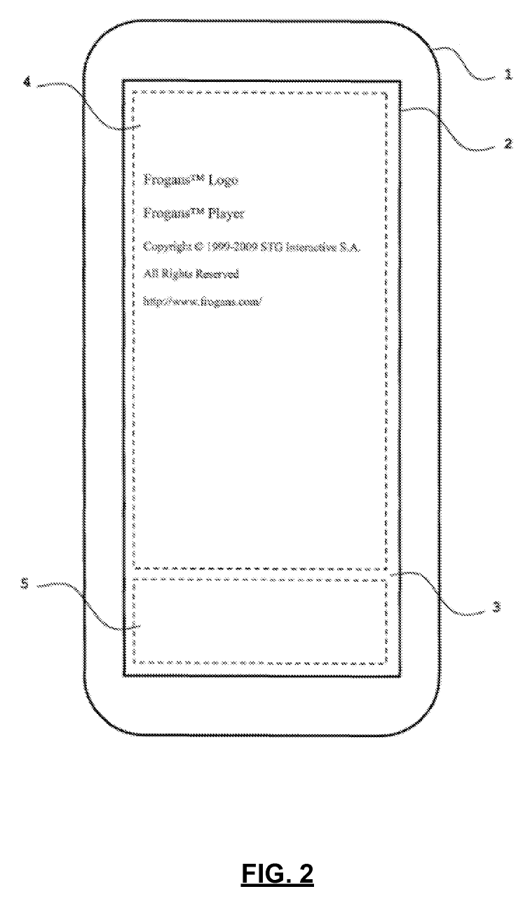

FIG. 1 describes an embodiment of the invention. The electronic device (1) comprises a touchscreen (2). The display surface (3) of the touchscreen (2) provides two display zones:

the larger display zone is the informational display zone (4), dedicated to the display of the graphical and textual informational content (6), some of them being functional objects (7 to 11)

the smaller display zone is the command display zone (5), dedicated to the display of tactile command icons and a command pad (12) in order to command the modification of the informational content (6) displayed in the informational display zone (4).

The functional objects (7 to 11) are displayed in the informational content (6). Each of the functional objects (7 to 11) is associated with a corresponding processing function. These functions are not tactually activated by a touch at the display location corresponding to functional objects displayed in the informational content (6). The functional objects (7 to 11) may be of any size, including small sizes, depending on the design of the informational content (6)

The activation of the corresponding processing function requires a first step of selecting one of the functional objects (7 to 11) by a tactile action in the command pad (12), and further, activating the selected functional object (7 to 11) by an additional tactile action. A drawback in the solution is the necessity to reserve a zone of the display surface (3) for the command display zone (5). The reserved command display zone (5) cannot be used for presenting the informational content (6). However, the reserved command display zone (5) could be typically limited to less than 20% of the display surface (3).

To enhance the user's experience, each selection of a functional object (7 to 11) can be accompanied by a sound, a vibration or an other haptic effect on the device. To enhance the user's experience, the sensitivity of the command pad (12) can vary, depending on the velocity and/or the amplitude of the tactile action. It can also depend on changes in the direction of the tactile action. For example, if the tactile action corresponds to the sliding of the finger on the command pad (12), passing from one selection to another may require a minimum sliding distance in either direction.

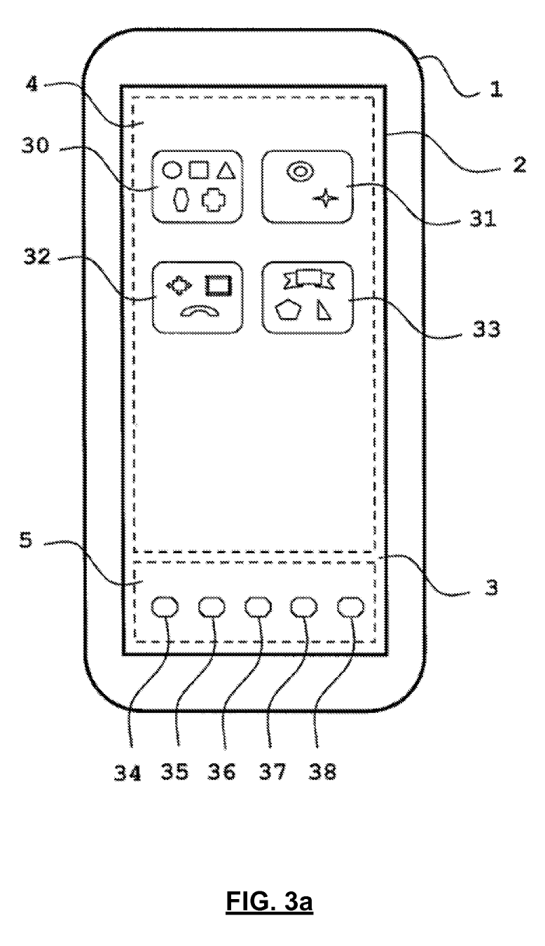

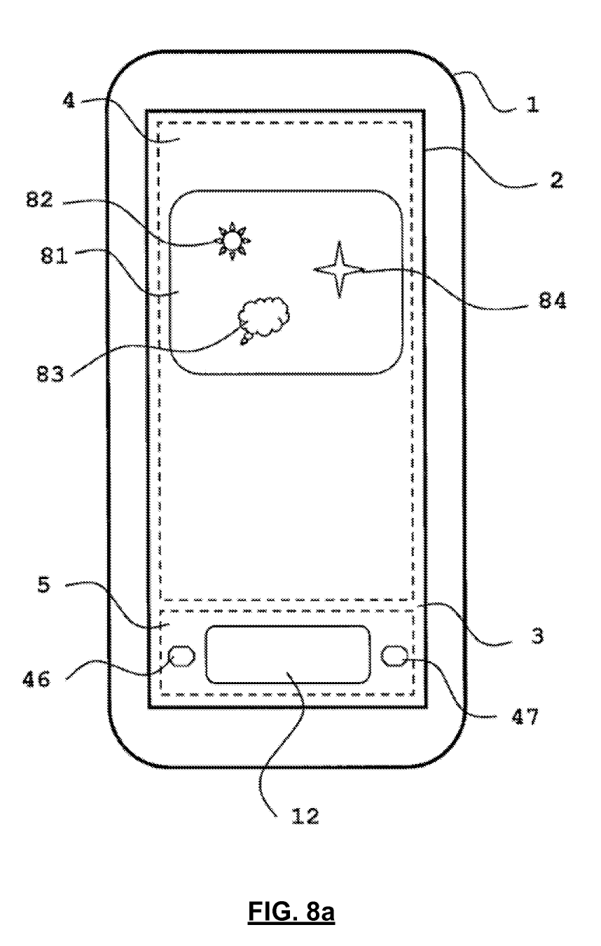

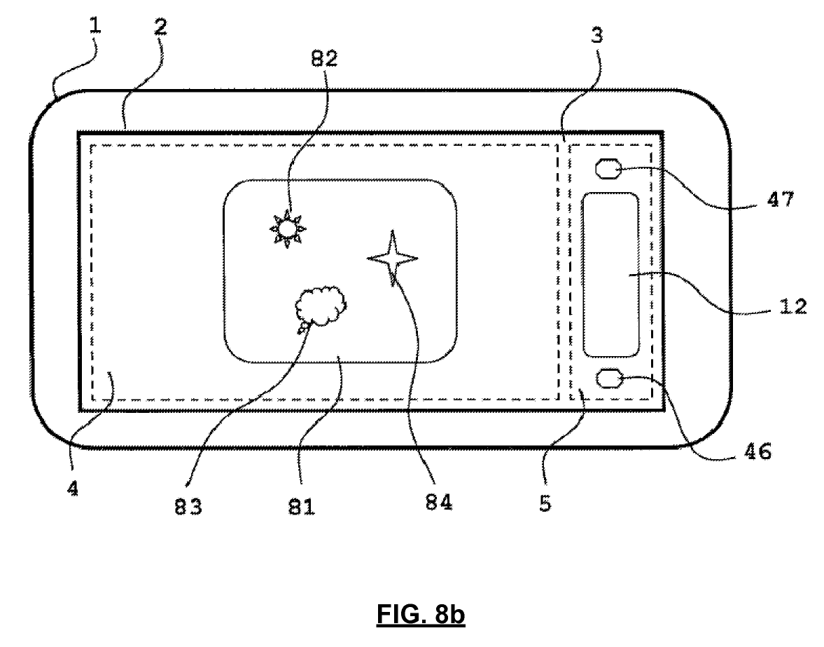

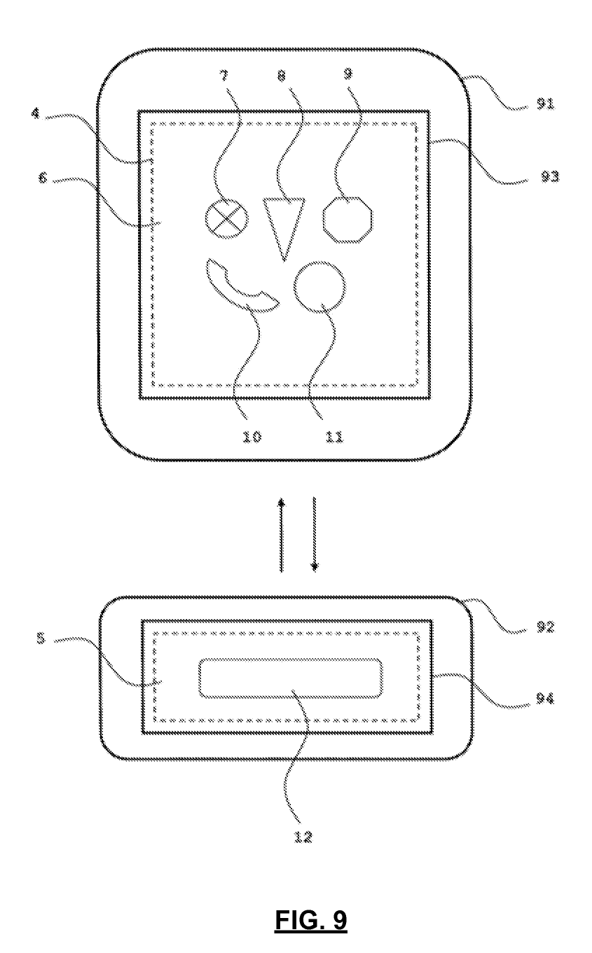

FIGS. 2 to 8 illustrate this implementation for touchscreen mobile devices running operating systems such as Windows CE™, Android™, Symbian™ OS and iPhone™ OS. In this implementation, the informational content (6) is called a Frogans™ site. 7

### Start Screen

FIG. 2 shows an example of a start screen. During the loading of the program in the active memory, both the informational display zone (4) and the command display zone (5) are inactive. The informational display zone (4) shows information about the program, i.e. “Frogans™ Player” program provided by STG Interactive S.A.

### Mosaic View Displaying Four Frogans™ Sites Opened on the Device

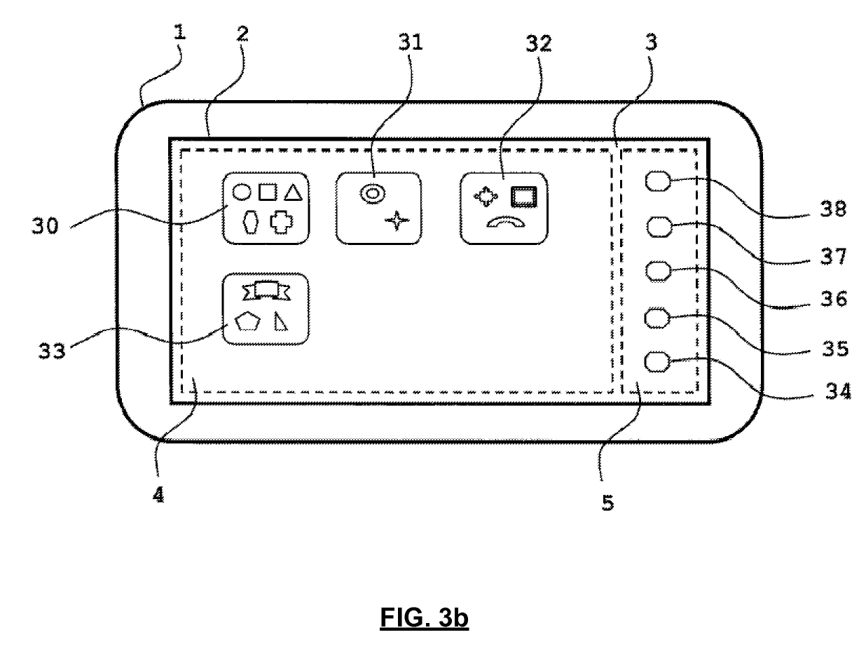

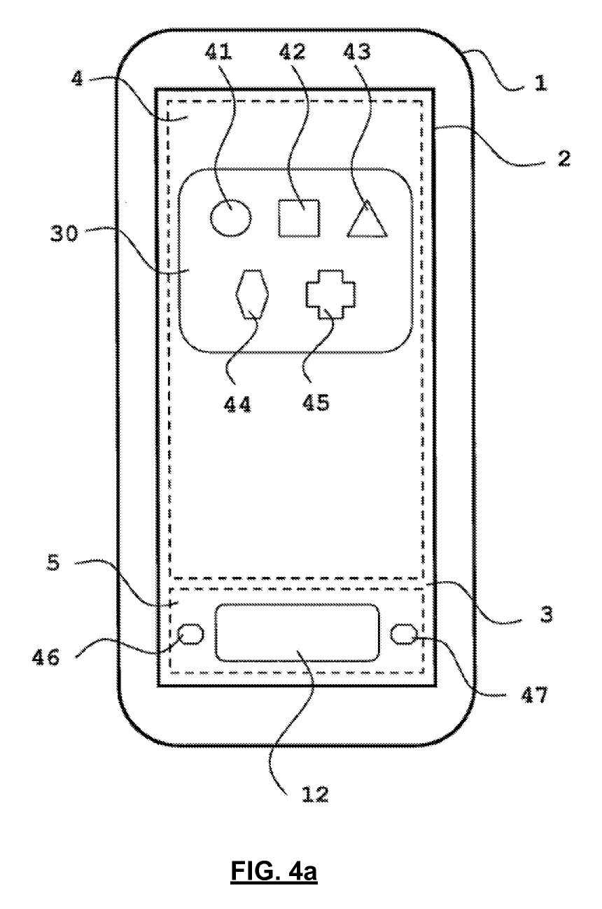

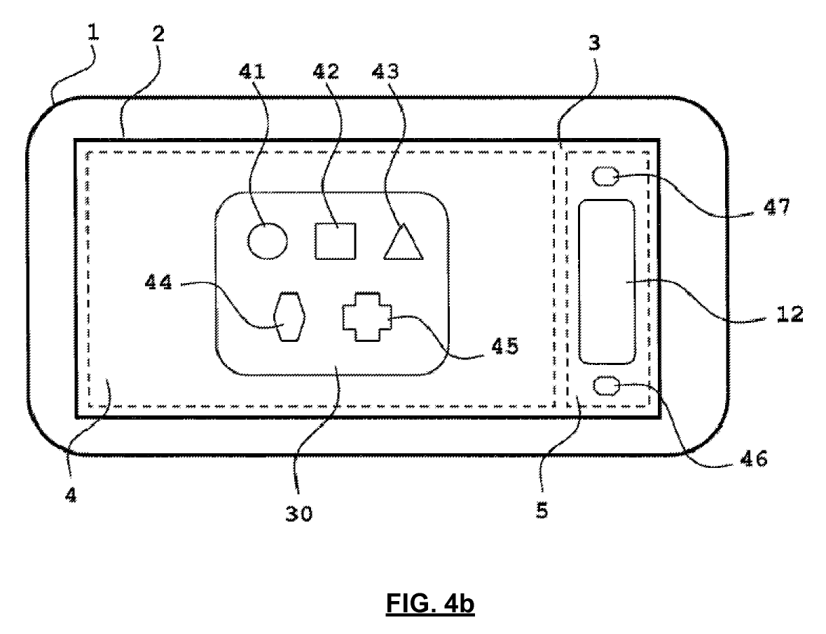

FIGS. 3a and 3b show an example of a mosaic view displaying, in small size, four informational content (30, 31, 32, 33) opened on the device. Each informational content is associated with a Frogans™ site in this example. But it could also be associated with a widget or a website.

The display surface (3) can be oriented in “Portrait mode” (FIG. 3a) or in “Landscape mode” (FIG. 3b). If the number of Frogans™ sites opened on the device exceeds the display capacity of the informational display zone (4), additional mosaic views are created. The user can slide his finger over the mosaic view parallel to the command display zone (5) (horizontally in portrait mode and vertically in landscape mode) to scroll between the different views of the mosaic.

A single touch (tap) on a Frogans™ site in the mosaic view gives access to the interactive view for navigating that Frogans™ site. The command display zone (5) contains (from left to right in portrait mode and from bottom to top in landscape mode) five buttons for accessing:

the menu of Frogans™ Player (34)

the Frogans™ address input interface (35)

the Frogans™ favorites list (36)

the recently visited list (37)

the theme selector (38).

The user makes a single touch (tap) in the informational content (30) displayed in the mosaic view, corresponding to a specific Frogans™ site, to start navigating that Frogans™ site.

### Interactive View for Navigating a Frogans™ Site Using the Solution: Step 1 of 5

FIGS. 4a and 4b show an example of step 1 of 5 of an interactive view for navigating a Frogans™ site using the solution. The display surface (3) can be oriented in “Portrait mode” (FIG. 4a) or in “Landscape mode” (FIG. 4b). A single touch (tap) on the Frogans™ site gives access to the mosaic view.

Five functional objects (41 to 45) are displayed in the informational content (30). The user can slide his finger over the Frogans™ site parallel to the command display zone (5) to scroll between the different Frogans™ sites opened on the device. If the user slides his finger over the Frogans™ site perpendicular to the command display zone (5), the Frogans™ site is resized on screen (becoming smaller if the movement is toward the command display zone (5), larger otherwise).

The command display zone (5) contains two buttons for accessing:

the menu of Frogans™ Player (46)

the menu of the Frogans™ site (47)

It also contains the command pad (12), positioned between the two buttons (46, 47). In step 1, the user has not yet slid his finger on the command pad (12).

### Interactive View for Navigating a Frogans™ Site Using the Solution: Step 2 of 5

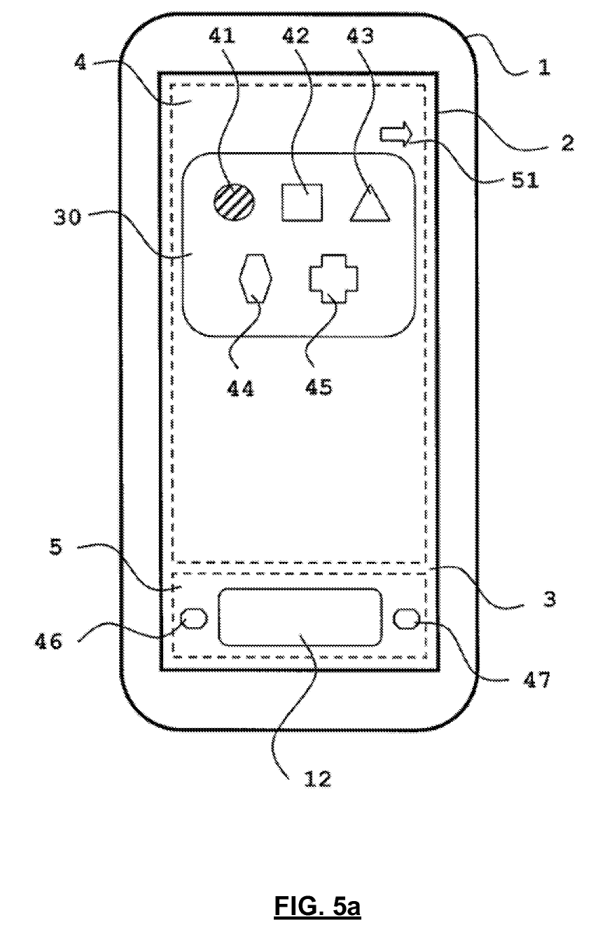

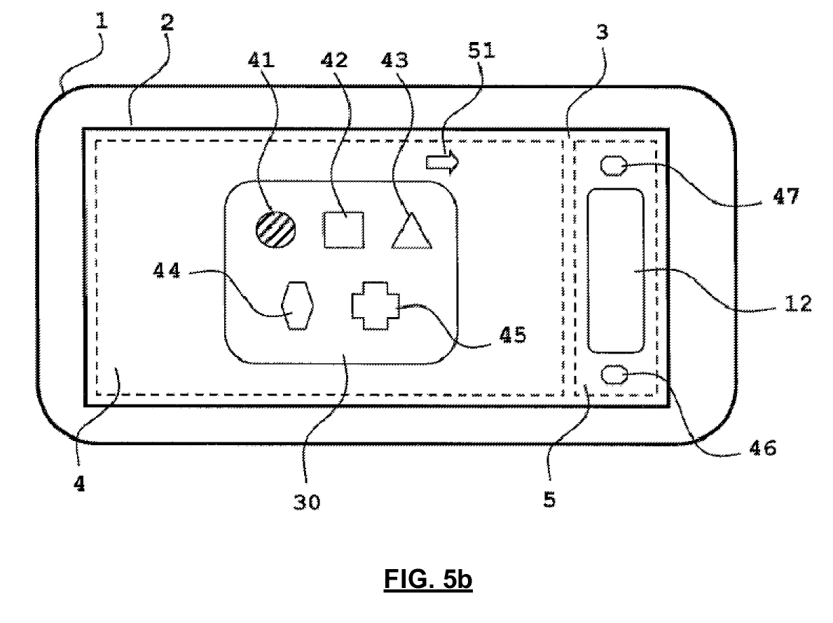

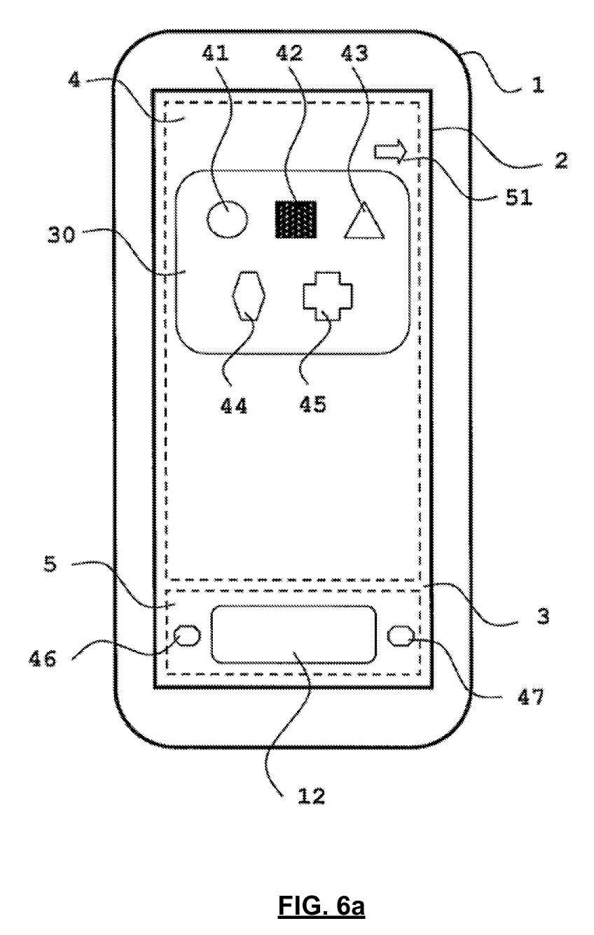

FIGS. 5a and 5b show an example of step 2 of 5 of an interactive view for navigating a Frogans™ site using the solution. The display surface (3) can be oriented in “Portrait mode” (FIG. 5a) or in “Landscape mode” (FIG. 5b).

In step 2, the user has started to slide his finger on the command pad (12) (from left to right in portrait mode and from top to bottom in landscape mode). A functional object (41) among the five displayed functional objects (41 to 45) is now selected by a slide of the finger on the command pad (12). A destination flag (51) is displayed above the Frogans™ site in the informational display zone (4), indicating that the selected functional object (41) corresponds to the navigation to another page in the Frogans™ site.

To help the user in navigating, six different destination flags can be displayed, corresponding to:

another page in the Frogans™ site

an input form in the Frogans™ site

a link to another Frogans™ site

a link to a web page

a link to a secured web page (SSL)

a link to an email address.

### Interactive View for Navigating a Frogans™ Site Using the Solution: Step 3 of 5

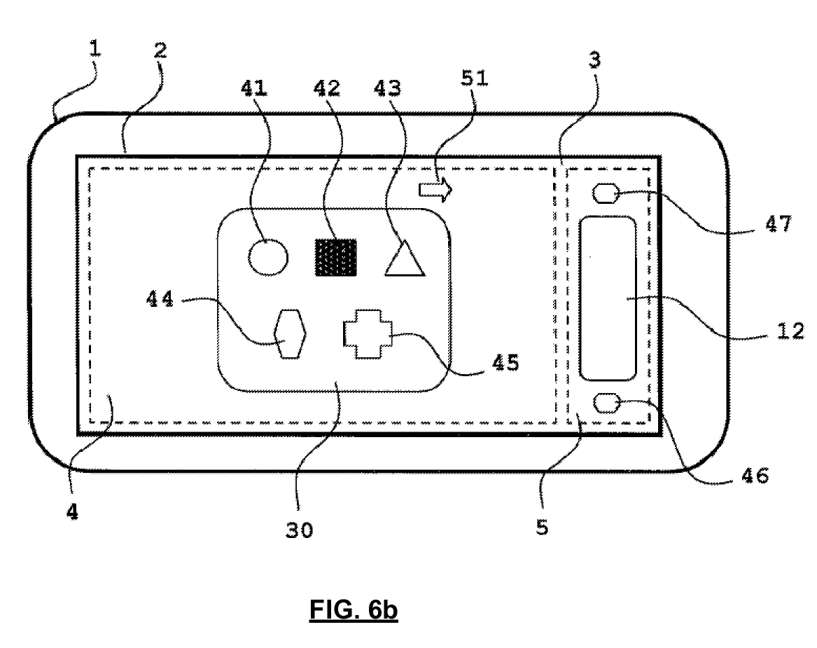

FIGS. 6a and 6b show an example of step 3 of 5 of an interactive view for navigating a Frogans™ site using the solution. The display surface (3) can be oriented in “Portrait mode” (FIG. 6a) or in “Landscape mode” (FIG. 6b).

In step 3, the user has continued to slide his finger on the command pad (12) (from left to right in portrait mode and from top to bottom in landscape mode). Another functional object (42) among the five displayed functional objects (41 to 45) is now selected by a slide of the finger on the command pad (12). A destination flag (51) is displayed above the Frogans™ site in the informational display zone (4), indicating that the selected functional object (42) corresponds to a navigation link to another page in the Frogans™ site. By sliding the finger in the opposite direction on the command pad (12) (from right to left in portrait mode and from bottom to top in landscape mode), the previously selected functional object (41) can be selected again.

### Interactive View for Navigating a Frogans™ Site Using the Solution: Step 4 of 5

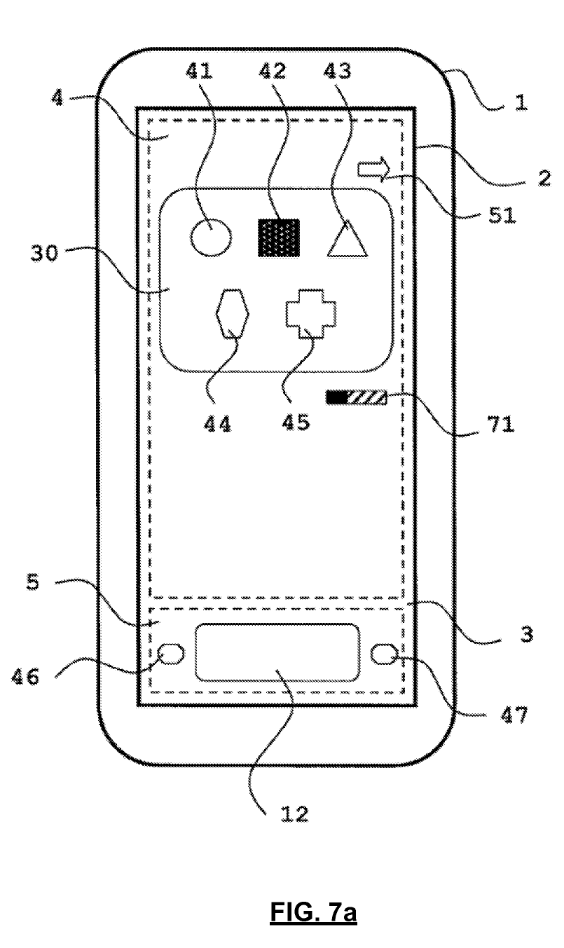

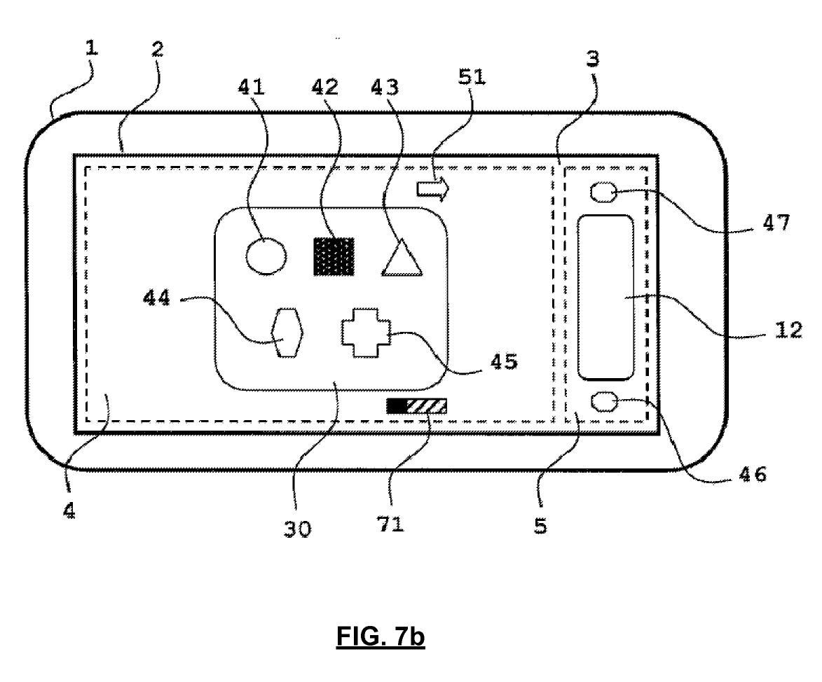

FIGS. 7a and 7b show an example of step 4 of 5 of an interactive view for navigating a Frogans™ site using the solution. The display surface (3) can be oriented in “Portrait mode” (FIG. 7a) or in “Landscape mode” (FIG. 7b).

In step 4, the user has stopped sliding his finger and has made a single touch (tap) on the command pad (12). Navigation to another page in the Frogans™ site has started. A progress bar (71) is displayed below the Frogans™ site in the informational display zone (4). During the loading of the new page, the user can still select another functional object corresponding to another action. He may also scroll to other Frogans™ sites opened on the device and may access the mosaic view.

### Interactive View for Navigating a Frogans™ Site Using the Solution: Step 5 of 5

FIGS. 4a and 4b show an example of step 5 of 5 of an interactive view for navigating a Frogans™ site using the solution. The display surface (3) can be oriented in “Portrait mode” (FIG. 4a) or in “Landscape mode” (FIG. 4b).

In step 5, the new page of the Frogans™ site, corresponding to a new informational content (81), is now loaded and displayed. Three functional objects (82 to 84) are displayed in the informational content (81). The user can continue to navigate the Frogans™ site, as he did in the previous steps.

FIG. 9 shows a particular embodiment of the invention whereas the electronic device is split in two paired apparatus, i.e. a main apparatus (91) and a remote apparatus (92).

The main apparatus (91) is a TV set including a screen (93) providing an informational display zone (4). This informational display zone (4) is dedicated to the display of the graphical and textual informational content (6), some of which are functional objects (7 to 11). This informational display zone (4) is a Picture In Picture display zone or an overlaying zone on top of the TV program display. In a particular embodiment, the informational display zone (4) is a 30 representation, implemented in order to show the functional objects (7 to 11) in a foreground visual layer. The TV set may be connected to a set top box.

The remote apparatus (92) is a remote control including a touchscreen (94) providing a command display zone (5) dedicated to the display of tactile command icons and a command pad (12). The graphical representations of the command icons and of the command pad (12) are transmitted by the main apparatus (91) to the remote apparatus (92).

These tactile command icons and the command pad (12) displayed on this display zone (5) are used for the acquisition of selection events that are transmitted by the remote apparatus (92) to the main apparatus (91). This selection will modify one of the functional objects (7 to 11) of the informational display zone (4).

In a particular embodiment, the remote apparatus (92) comprises a haptic touchscreen. The haptic effect is activated first at the time of the acquisition by the local electrical circuit of a new command, and secondly at the time of the acquisition of the said new command by the electrical circuit of the main apparatus (91). The first effect may be a negative motion (pressing down effect), and the second effect a positive motion (push back effect). It can also be a low amplitude vibration for the first effect, and an amplified vibration for the second effect.

In another particular embodiment, the electrical circuit of the remote apparatus (92) comprises a memory for storing the graphical representation of the functional objects (7 to 11) of the informational display zone (4) and the graphical representation of the tactile icons and of the command pad (12). This configuration avoids the transmission of the graphical representation from the main apparatus to the remote apparatus, and reduces the cost of the device and the data flow between both apparatus.

What is claimed is:

1. An electronic device comprising:
a touchscreen; and
an electrical circuit that controls a display of the touchscreen and detects user contact with a surface of the touchscreen, wherein:
the electrical circuit divides the display into at least two distinct display zones, the at least two distinct display zones including an informational display zone and a command display zone,
the informational display zone displays informational content including functional objects, each of the functional objects being associated with a data processing function,
the command display zone displays a graphic representation of a command pad,
in response to detecting a first predetermined tactile action on the command pad, the electrical circuit graphically modifies one of the functional objects of the informational display zone to indication selection of the one of the functional objects, and
in response to detecting a second predetermined tactile action, the electrical circuit initiates execution of the data processing function associated with the one of the functional objects.

2. The electronic device of claim 1 wherein selection of the associated functional objects is independent of user contact with the information display zone.

3. The electronic device of claim 1 wherein the electrical circuit only detects the user contact with the touchscreen at a single location on the touchscreen at a time.

4. The electronic device of claim 1 wherein positions along a path from one end of the command pad to an opposite end of the command pad correspond respectively to each of the functional objects.

5. The electronic device of claim 1 further comprising an orientation sensor, wherein the electrical circuit adjusts relative position of the information display zone and the command display zone in response to the orientation sensor.

6. The electronic device of claim 1 wherein the electrical circuit outputs on the display a plurality of command display zones including the command display zone.

7. The electronic device of claim 1 wherein the command pad is oriented parallel to one dimension of the touchscreen, and wherein selection of the functional objects is made in an order parallel to the one dimension.

8. The electronic device of claim 1 wherein in response to a specific user action, the informational display zone is resized and the command display zone is displayed in an area remaining after resizing of the informational display zone.

9. An electronic system comprising:
a main apparatus including:
a screen; and
a first electrical circuit that controls a display of the screen, wherein:
the first electrical circuit selectively dedicates at least a portion of the screen to an informational display zone, and
the informational display zone displays informational content including functional objects, each of the functional objects being associated with a data processing function; and
a remote apparatus comprising:
a touchscreen; and
a second electrical circuit that controls a display of the touchscreen and detects user contact with a surface of the touchscreen, wherein:
the second electrical circuit selectively dedicates at least a portion of the touchscreen to a command display zone, and
the command display zone displays a graphic representation of a command pad,
wherein in response to detecting a first predetermined tactile action on the command pad, the main apparatus graphically modifies one of the functional objects of the informational display zone to indication selection of the one of the functional objects, and
wherein in response to detecting a second predetermined tactile action, the electronic system initiates execution of the data processing function associated with the one of the functional objects.

10. The electronic system of claim 9 wherein the remote apparatus is a remote control.

11. A method comprising:
visually displaying at least one control interface on a display of a first electronic device;
selectively visually displaying a command pad as one of the at least one control interface;
detecting user contact with a surface of the display;
detecting movement of the user contact on the surface of the display corresponding to the command pad;
changing a selected functional object of a plurality of functional objects in response to the detected movement, wherein the plurality of functional objects are visually displayed on a second display of a second electronic device, and wherein each of the plurality of functional objects is associated with a corresponding processing function;
causing the second display to visually indicate selection of the selected functional object;
detecting a predetermined type of the user contact with the surface of the display; and
initiating execution of the processing function corresponding to the selected functional object in response to detection of the predetermined type of the user contact.

12. The method of claim 11 further comprising selectively displaying the command pad on substantially an entirety of a visible area of the display.

13. The method of claim 11 wherein the command pad is contained within a rectangular shape with a first side that is longer than a second side, the method further comprising:
changing the selected functional object to a next one of the plurality of functional objects in response to the detected movement being in a first direction parallel to the first side; and
changing the selected functional object to a previous one of the plurality of functional objects in response to the detected movement being in a second direction parallel to the first side, wherein the first direction is opposite to the second direction.

14. The method of claim 11 wherein the predetermined type of the user contact is momentary presence of contact with the surface of the display.
